(19) United States
(12) Patent Application Publication
(10) Pub. No.: US 2009/0236475 A1
(43) Pub. Date: Sep. 24, 2009

(54) LIFT CHAMBER

(75) Inventor: Robert A. Leibow, Urbandale, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Vonnie Leibow, Urbandale, IA (US)

(21) Appl. No.: 12/408,316

(22) Filed: Mar. 20, 2009

Related U.S. Application Data
(60) Provisional application No. 61/038,086, filed on Mar. 20, 2008.

(51) Int. Cl. B64C 29/00

(52) U.S. Cl. 244/23 C

(57) ABSTRACT

A lift device having a generally cylindrical chamber formed by a top wall, a bottom wall, an outer wall and an inner wall. A plurality of lift members are mounted to the interior of a chamber wall and at least one fan is mounted within the chamber and an engine operatively connected to at lease one fan.

### CROSS REFERENCE TO RELATED APPLICATION

This application claims the benefit of U.S. Provisional Application No. 61/038,086 filed Mar. 20, 2008.

### BACKGROUND OF THE INVENTION

This invention is directed toward a lifting chamber for an aircraft and more particularly to a sealed chamber that creates lift by airflow.

Lifting devices, such as a wing or helicopter propeller, are well known in the art, and rely upon movement to create sufficient airflow to lift an aircraft off the ground. Alternatively, a Harrier jet has blowers that provide airflow in a downward direction. While serving a purpose, conventional lifting devices leave room for improvement. Conventional aircraft require space and substantial movement to create lift, while the Harrier jet is unstable. Therefore, there exists a need in the art for a lifting device that improves upon these deficiencies.

### BRIEF SUMMARY OF THE INVENTION

A lift device having a generally cylindrical chamber formed by a top wall, a bottom wall, an outer wall and an inner wall. A plurality of lift members are mounted to the interior of a chamber wall and at least one fan is mounted within the chamber and an engine operatively connected to at lease one fan.

### BRIEF DESCRIPTION OF THE DRAWINGS

FIG. 1 is a side elevation view of the lift chamber.

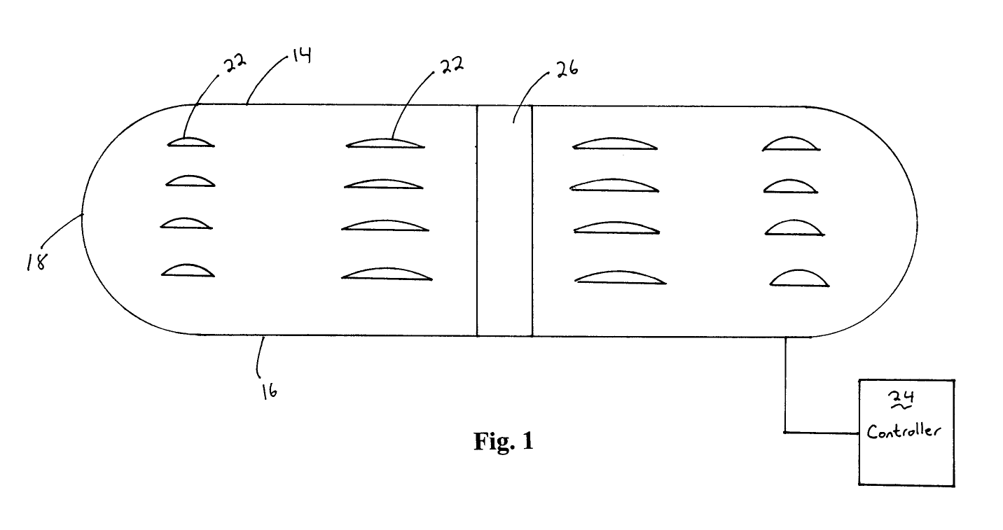

FIG. 2 is a top sectional view of the lift chamber.

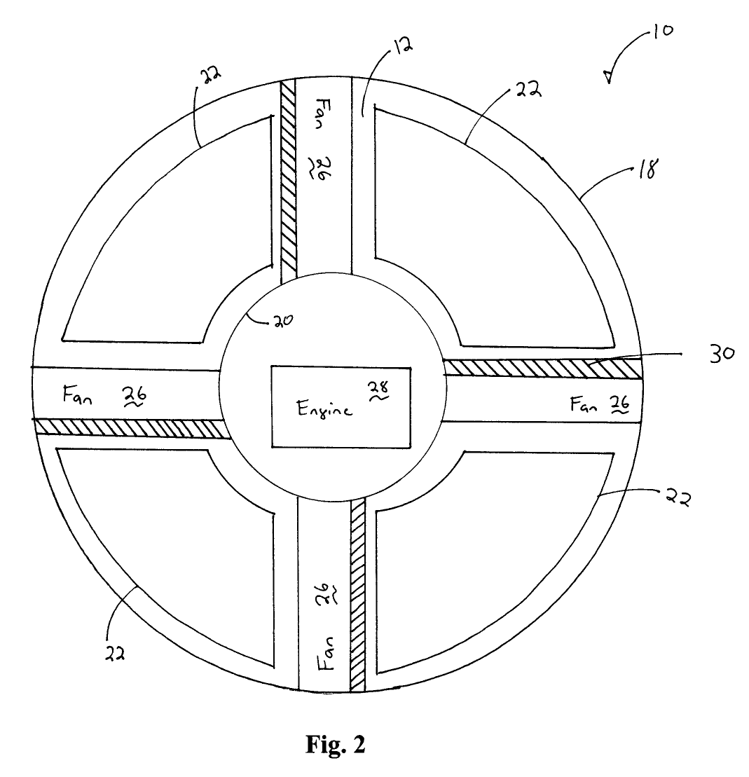

### DETAILED DESCRIPTION OF THE PREFERRED EMBODIMENT

Referring to the figures, the lifting device 10 has a generally cylindrical chamber formed by a top wall 14, a bottom wall 16, an outer wall 18 and an inner wall 20. Disposed within the chamber are a plurality of lift members 22 or wings that are mounted to the interior of the chamber walls in any conventional manner. In an alternative embodiment, the lift members are pivotally mounted to the chamber walls and operatively connected to a controller 24 for selected movement by an operator.

Also mounted within the chamber 12 is at least one, and preferably four fans 26. The fans 26 are operatively connected to an engine 28 such that when activated, the fans 26 generate airflow through the sealed chamber 12 and over the lift members 22.

In an alternative embodiment one or more grids 30 are positioned proximate to the fans 26 to break up and deflect air flow over the lift members 22 to avoid turbulence. Liquid, gas, or solid particles can be added to the chamber 12 to thicken the air.

In a preferred embodiment, the top wall 14 of chamber 12 is mounted to the bottom of a device such as an airplane, a submarine, spacecraft or the like. Alternatively, any portion of chamber 12 is mounted by any means to any device in any position.

In operation, the engine 28 is activated which in turn activates the fans 26. As the rotational drive speed of the engine 28 increases so does the rotational speed of the fans 26 which creates airflow within the sealed chamber 12. As sufficient airflow is created and crosses the lift members 22, sufficient force is created to lift the device and any object attached thereto. The device can be used with a variety of objects such as a submarine, airplane, or space craft. The device, unlike conventional lift devices is capable of re-entry into the atmosphere at slow and controlled speeds.

What is claimed is:

1. A lift device comprising:
a generally cylindrical chamber having a top wall, a bottom wall, an outer wall, and an inner wall;
a plurality of lift members mounted within the chamber;
at least one fan mounted within the chamber; and
an engine operatively connected to at least one fan.

2. The lift device of claim 1 wherein the lift member is a wing.

3. The lift device of claim 1 further comprising the lift member is pivotally mounted to the chamber.

4. The lift device of claim 1 further comprising four fans mounted within the chamber.

5. The lift device of claim 4 wherein the four fans are positioned 90° from one another.

6. The lift device of claim 1 further comprising a controller operatively connected to the lift members

7. The lift device of claim 1 further comprising a grid positioned proximate to at least one fan.

8. The lift device of claim 1 wherein the chamber is sealed.

9. The lift device of claim 1 wherein the chamber contains an air thickener.
